(19) United States
(12) Patent Application Publication
(10) Pub. No.: US 2009/0272214 A1
(43) Pub. Date: Nov. 5, 2009

(54) Method and apparatus for minimizing variations in the angular velocity of a rotating member

(76) Inventor: James Ossi, Darien, CT (US)

Correspondence Address: EPSTEIN DRANGEL BAZERMAN & JAMES, LLP, 60 EAST 42ND STREET, SUITE 820, NEW YORK, NY, 10165, US

(21) Appl. No.: 12/321,923

(22) Filed: Jan. 27, 2009

Related U.S. Application Data
(60) Provisional application No. 61/126,639, filed on May 5, 2008.

(51) Int. Cl. F16H 55/17

(52) U.S. Cl. 74/437

(57) ABSTRACT

A method and apparatus for altering (minimizing or maximizing) characteristic (angular velocity or torque) variations of a rotating member connected to an engine consisting of a set of engaged circular gears modified in shape as a function of the “wave train signature” of the engine to which the gearset is connected such that the “wave train signature” of the rotating member is essentially “wrapped” around circular gears to form a noncircular gearset that alters the variations of the rotating member.

### BACKGROUND OF THE INVENTION

1. Field of the Invention

The present invention relates to a method and apparatus for altering (minimizing or maximizing) the angular velocity variations of a rotating member such as the crankshaft or driven wheel of an engine.

2. Description of Prior Art Including Information Disclosed Under 37 CFR 1.97 and 1.98

The rotating crankshaft of an internal combustion engine, the rotating wheel driven by the pushrod of a steam engine and similar rotating members exhibit varying characteristics such as angular velocity and torque as they rotate due to the inherent nature of the engines or linkages that drive such member. Such variations may lead to mechanical vibrations in the components being driven by the engine or linkage. If the vibrations are strong enough or occur at a high enough frequency, damage to the driven components may result. The present invention provides a method and apparatus for minimizing those variations by utilizing a set of non-circular gears to provide more uniform transmission of rotation or torque from the engine to the components driven by the engine, such as the drive train of a vehicle or machinery of various types.

In particular, minimizing the angular velocity or torque variations of the rotating member will reduce stresses on the driven mechanical parts and add stability to wheels, propellers, water screws etc. driven by the engine. It will also reduce fatigue on the human operator of the machinery and on the driver and passengers of a vehicle driven by the engine. Further, less vibration of the wheel of an automobile, for example, results in better traction, particularly important in slippery conditions.

The angular velocity of an engine driven rotating member varies for several reasons. In the case of internal combustion engines, the variations are caused by the explosions in cylinders that occur at different points of the engine cycle. In the case of a pushrod driven wheel of a steam engine, the variations are caused by the conveyance of motion through the pushrod as the pushrod changes position relative to the wheel.

Changes in the characteristics of engine driven rotating shafts and wheels have been addressed with various mechanisms, such as flywheels and by adding or rearranging cylinders. In addition, various gearing arrangements have been employed.

The gearsets disclosed in the patent application of Publication Number US2060225690A1 applied for by Anatoly Arov are a good example. The Arov application employs a selective leverage technique utilizing circular gears with offset axes of rotation or non-circular gears of various configurations. However, in order to achieve a practical alteration of the angular velocity variations in a real engine, the Arov gearsets would have to be repeated for each piston of the engine, thus adding unacceptable mechanical complexity to the system. See also U.S. Pat. No. 6,401,683 to Stokes et al. and U.S. Pat. No. 5,644,917 to McWaters, which teach complex noncircular torque transmission gearset arrangements.

There are many devices that use noncircular gears for varying the transmission ratio. See for example U.S. Pat. No. 6,289,754; U.S. Pat. No. 4,685,348; U.S. Pat. No. 5,557,934; U.S. Pat. No. 6,059,550; U.S. Pat. No. 6,991,522 and U.S. Patent Publication No. 20060035738A1, all of which disclose the use of noncircular gearsets for various applications.

However, none of the above mentioned references address the problem of reducing the angular velocity variations of a rotating member such as the crankshaft of an internal combustion engine. More importantly, none of those references teach altering the characteristics of a rotating member by utilizing the “wave train signature” of the engine to which the gearset will be connected in order to design a gearset specific to that type of engine.

It is, therefore, a prime object of the present invention to provide a method and apparatus for minimizing variations in the angular velocity of a rotating member.

It is another object of the present invention to provide a method and apparatus for minimizing variations in the angular velocity of a rotating member resulting in the diminution of vibrations in the components driven by the rotating member.

It is another object of the present invention to provide a method and apparatus for minimizing variations in the angular velocity of a rotating member using a noncircular gearset designed in accordance with the “wave train signature” of the type of engine to which the gearset will be connected.

It is another object of the present invention to provide a method and apparatus for minimizing variations in the angular velocity of a rotating member using a noncircular gearset with gears shaped as a function of the ratio of the actual instantaneous angular velocity of the rotating member to the desired instantaneous angular velocity of the rotating member at a plurality of points in the rotation cycle of the rotating member.

It is another object of the present invention to provide a method and apparatus for minimizing variations in the angular velocity of a rotating member using a noncircular gearset wherein the ratio of the actual to the desired instantaneous angular velocities of the rotating member at each of a plurality of angular positions in the rotation cycle of the rotating member is divided by two and used to modify the length of the radius of one gear and the length of the aligned radius of the other gear at that angular position.

For purposes of simplicity in this disclosure, the word “member” will be used to denote any rotating shaft or wheel. Further, although the method and apparatus of the present invention will be explained in terms of minimizing the angular velocity variations of the rotating member, it is to be understood that the invention is not to be limited to that particular example and could be used to obtain other alterations of angular velocity or other alterations of other characteristics of a rotating member, such as torque variations.

### BRIEF SUMMARY OF THE INVENTION

In order to achieve the above stated objects, and in accordance with one aspect of the present invention, a method is provided for minimizing angular velocity variations of a rotating member using a gearset connected to the member including engaged gears. The method includes the step of modifying the shape of each of first and second circular gears, each having an axis of rotation located at the center point thereof, to form engaged gears with a noncircular shape that is a function of the “wave train signature” of the rotating member to which the gearset is connected.

The step of modifying the shape of each of the gears includes the step of determining a ratio for the rotating member at each of a plurality of angular positions in a rotation cycle thereof by dividing the actual instantaneous angular velocity of the rotating member by the desired instantaneous angular velocity of the rotating member at each of the plurality angular positions.

For purposes of this disclosure, the length of each radius of a circular gear will be considered to have a length of 1.00. The “difference value” is defined as the difference between the ratio and 1.00, at each of the plurality of angular positions. The “difference value” can be positive or negative. Where the difference value is positive, the length of a radius of the noncircular gear associated with that angular position will be greater than 1.00 and that radius will be considered to define a “hill” on the circumference of the gear. Similarly, where the difference value is negative, the length of the radius of a noncircular gear associated with at angular position will be less than 1.00 and that will be considered to define a “valley” on the circumference of the gear.

The step of modifying the shape of each of the gears further includes the step of determining the “difference value” for each of a plurality of angular positions as a function of the difference between the ratio and 1.00 at that angular position.

The step of modifying the shape of each of the gears further includes dividing the “difference value” associated with each of the plurality of angular positions by two to obtain half the difference value for each of the plurality of angular positions.

The step of modifying the shape of each of the gears further includes forming one of the gears by modifying the length of the radius of one of the gears, at each of the angular positions as a function of half the difference value.

The step of modifying the shape of each of the gears further includes forming the other of the gears by modifying the length of the radius of the other of the gears, at each of the angular positions thereof, as a function of half the difference value.

The step of modifying the shape of the gears further comprises the step of modifying the length of the radius of one gear and the aligned radius of the other of the gears, at each of the angular positions, in opposite directions such that the radius of one of the gears forms a “hill” and the aligned radius on the other of the gears forms a “valley” for that angular position.

The step of modifying the shape of each of the gears further includes repeating the step of modifying the gears for additional cylinders present in the engine driving the rotating member.

In accordance with another aspect of the present invention, apparatus is provided for minimizing angular velocity variations of a rotating member. The apparatus includes a gearset connected to the member. The gearset includes shape modified first and second circular engaged gears. Each of the first and second gears has an axis of rotation located at its center point. Each of the circular gears has a shape which is modified as a function of the “wave train signature” of the rotating member to which the gearset is connected.

Each of the shape modified gears has a plurality of spaced radii respectively corresponding to a plurality of angular positions of the rotating member. Each of the radii has a length that is a function of the ratio of the rotating member at each of the plurality of angular positions in a rotation cycle thereof obtained by dividing the actual instantaneous angular velocity of the rotating member at that angular position by the desired instantaneous angular velocity of the rotating member at that angular position.

The length of the radii of each shape modified gear associated with each of the plurality of angular positions of the rotating member is a function of the difference between the ratio and 1.00 (the “difference value”) at that angular position.

The length of the radii of each shape modified gear associated with each of the plurality of angular positions of the rotating member is a function of half the “different value” at that angular position.

The length of each radius of one of the shape modified gears is further obtained by adjusting the radius of a circular gear by half the difference value.

The length of each radius of the other of the shape modified gears is further obtained by adjusting the radius of a circular gear by half the difference value.

The length of each radius of one shape modified gear and the length of the aligned radius of the other shape modified gear are adjusted in opposite directions such that one radius creates a “hill” and the aligned radius creates a “valley” at each angular position.

The shape of each of the gears is further determined by modifying the radii of sections of the shape modified gears for additional cylinders present in the engine driving the rotating member.

### BRIEF DESCRIPTION OF THE SEVERAL VIEWS OF DRAWINGS

To these and to such other objects that may hereinafter appears, the present invention relates to a method and apparatus for minimizing the variations in angular velocity of a rotating member as described in detail in the following specification and recited in the annexed claims, taken together with the accompanying drawings, in which like numerals refer to like parts and in which:

FIG. 1 is a graphic representation of the angular velocity wave train signature of rotating shaft connected to a typical two cylinder, four stroke internal combustion engine running at the average idle speed of 800 rpm;

FIG. 2 is a representation of a gearset designed in accordance with the present invention to minimize the angular velocity variations of a rotating shaft with the wave train signature illustrated in FIG. 1;

FIG. 3 is a graphical representation of the angular velocity wave train signature of a rotating shaft connected to a typical four cylinder, four stroke internal combustion engine running at the average idle speed of 800 rpm; and

FIG. 4 is a representation of a gearset designed in accordance with the present invention to minimize the angular velocity variations of the rotating shaft with the wave train signature illustrated in FIG. 3.

### DETAILED DESCRIPTION OF THE INVENTION

It is well known to graph the angular velocity of a rotating member having repetitive variations in angular velocity or torque during one or a few revolutions. That graph represents the angular velocity wave train of the rotating member. The essence of the present invention is to translate the wave train “signature” of such a rotating member into the physical properties (shape) of the gears of a gearset for the purpose of altering (minimizing or maximizing) the variations of the angular velocity of the rotating member.

For simplicity of explanation, only variations in angular velocity, not torque, will be discussed in the following description. Further, the explanation will focus will be on minimizing those variations.

There are many reasons a member will have predictable variations in angular velocity as it rotates. The pushrod to wheel linkage used in old steam locomotives is an easy example to visualize. The angular velocity of the wheel varies as the pushrod attached to the piston of the steam engine acts on the wheel at side-dead-center and at top-dead-center.

Internal combustion engines, in fact, are impulse engines, have various numbers of cylinders arranged in different configurations, all driving a rotating crankshaft. The length of the piston stroke varies, ignition timings are different, and there are many other variations. Each engine type has its own angular velocity “wave train signature” representing the oscillating angular velocity of its crankshaft as the crankshaft rotates. Although different, each is generally wave shaped and is distinct to that type of engine. Engines also have torque signatures and other types of signatures as well. However, only the angular velocity signature will be discussed here.

The present invention relates to a method and apparatus in which the angular velocity “wave train signature” of a rotating member can be “wrapped around” the gears in a gearset in order to negate the very same signature that was used to create that particular gearset.

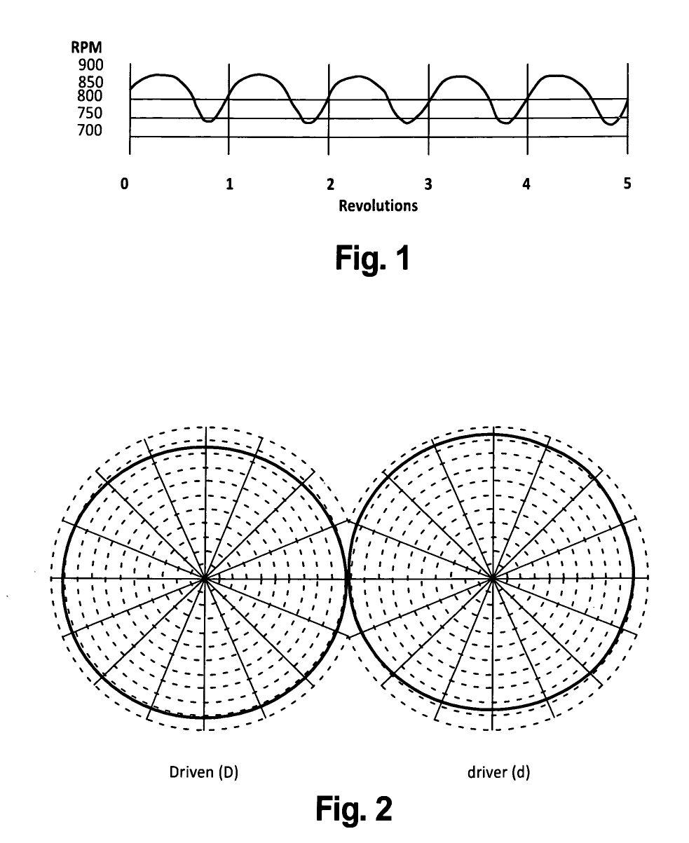

The graph of FIG. 1 is the generalized depiction of the angular velocity “wave train signature” of a crankshaft connected to typical a two cylinder, four stroke engine running at the average idle speed of 800 rpm. Other signatures, for example for cruising speed of 2,000 rpm, could have been selected. However, for simplicity of this example, 800 rpm is used.

Assuming that the firing order of the engine is symmetrical, if an engine tachometer reads a speed of 800 rpm, that speed represents an average speed of the rotating crankshaft for a single revolution. The graph of FIG. 1 indicates that the actual speed varies between 736 and 864 rpm during one revolution.

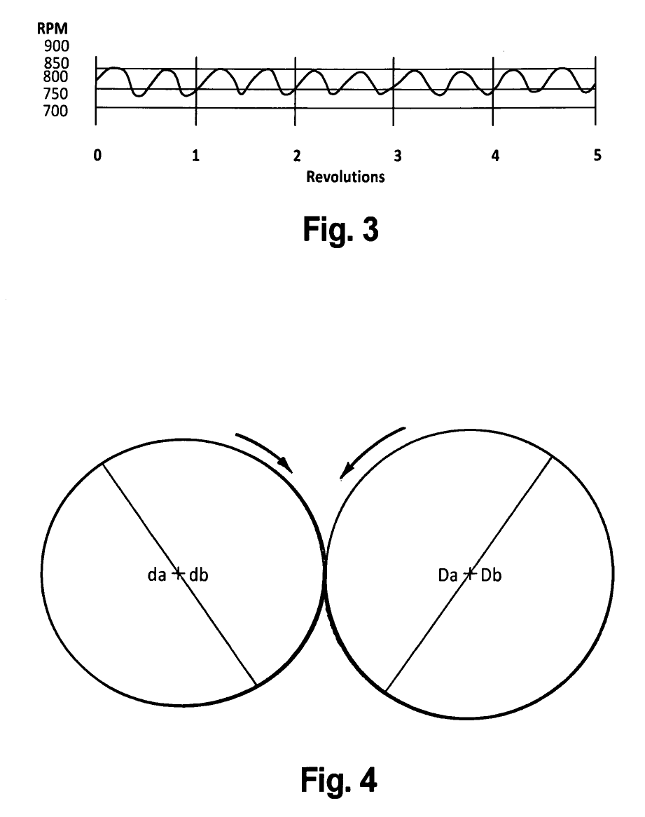

That graph shows a wavy line, moving above and below 800 rpm, which is the angular velocity “wave train signature” of the engine. The graph shows a reasonably uniform repetition from one revolution of the crankshaft to the next. The actual signature for a four stroke engine would include two revolutions per cycle, as depicted in FIG. 3. However, assuming all cylinders fire fairly equally and the crankshaft does not twist too much, the second revolution of the cycle looks much like the first. Hence, for simplicity, the implementation of the present invention as applied to the signature of an engine with a single revolution cycle is described.

A gear ratio (gr) for a circular gearset where d is the diameter of the drive gear and D is the diameter of the driven gear is defined mathematically using the formula:

gr=(π×d)/(π×D)=2r/2R=r/R . . . or simply: d/D.

This formula defines the ratio of the radius of each gear at the “pitch arc,” that is, the point where the radius of one gear aligns with the corresponding radius of the other gear such that the teeth of the gears engage and torque is transferred from the drive gear, connected to the engine, to the driven gear connected to the vehicle wheels, the machine parts etc., which do the actual work.

The method for determining the shape of each of the noncircular gears 10, 12 illustrated in FIG. 2 includes modifying the shape of each of first and second circular gears, each having an axis of rotation located at the center point thereof, to form noncircular gears 10, 12 with a shape that is a function of the “wave train signature” of the rotating member to which the gearset is connected, such that the output of the driven gear 12 of the gearset is always a constant speed, regardless of the variations in the speed of the drive gear 10.

That is achieved by selecting a plurality of angular positions in a revolution of the rotating member. Preferably, the selected positions are equidistant from each other. In this example, sixteen angular positions are selected, at 0 degrees, 22.5 degrees, 45 degrees, 67.5 degrees, 90 degrees, etc. For purposes of illustration, only sixteen angular positions have been chosen and the length of the corresponding 16 radii of each of the shape modified gears 10, 12 is determined for each of those positions. In practice, it is desirable to chose as many angular positions as is possible and thus calculate the lengths of as many radii as is possible to obtain the greatest accuracy.

As long as the gears are circular, the length of each radius of each gear, measured from the center point (axis of rotation) of the gear to the circumference of the gear will be same, and for this example, will be considered to have a value of 1.00.

In order to determine the shape of the noncircular gears in the gearset in accordance with the present invention, that is, to modify the shape of circular gears to define the noncircular shapes of gears of the invention, the length of the radius of each of the gears corresponding to each of the plurality of selected angular positions in the rotation cycle of the rotating member is altered to cancel out the angular velocity variations inherent in the engine.

That is accomplished by forming a ratio for each selected angular position of the rotating member by dividing the actual instantaneous angular velocity of the rotating member at that angular position by the desired instantaneous angular velocity of the rotating member at that angular position.

For example, at any selected angular position in the revolution cycle, if the actual instantaneous velocity of the rotating member is 864 rpm but an instantaneous velocity of 800 rpm at that position is desired in order to smooth out the variations, then the resulting ratio is 864/800=1.08 for that angular position. The length of the radius of one shape modified gear at that angular position and the length of the aligned radius of the other shape modified gear are both determined as a function of that ratio.

For each angular position in the rotation cycle of the rotating member, the length of the radius of one shape modified gear to the length of the aligned radius of the other shape gear necessary to achieve a uniform angular velocity at that angular position are each a function of the ratio of the actual instantaneous angular velocity of rotating member at that angular position to the desired instantaneous angular velocity of rotating member at that angular position.

If the ratio values were calculated for each angular position in the rotation cycle, and those values were plotted on a circular, “polar graph” and then cut into a gear blank, a noncircular gear would be slightly “lumpy” with relative “hills” and “valleys.” along its circumference because at one point on the circumference of the gear the length of the radius may be 1.08 (creating a “hill”), while the length of the radius at another point on the circumference of the gear may be 0.92 (creating a “valley”). Because these are relatively minor variations, the gear will appear to be generally round, but slightly off, as illustrated in FIG. 2.

With respect to FIG. 2, the solid lines represent the circumference of the shape modified gears 10, 12 (the gear teeth are omitted for clarity) obtained by altering the lengths of the radii of the gears at each of the angular positions. The shape of the gears is obtained by determining the length of each radii of each gear in accordance with the method of the present invention.

In the Figure, gears 10 and 12 may appear to be round because the shape modifications are relatively minor. In order to better visualize the modification of the shapes of the gears in accordance with the present invention, dotted lines depicting concentric circles, that is “true round,” are provided for purposes of visual comparison. It should be noted that for smoother running engines, the gears of the gears set would even appear to be more “round.”

Obviously one gear alone is useless. It needs a mate. If that mating gear was circular, that is, had a uniform radius length of 1.00, then the gears would not align correctly. A noncircular gear needs a mating gear where the “hill” of one gear dips into the “valley” of the mating gear. It should be noted that the shape modified gears in this example must start with the same circumference (that is, are round) and an equal number of teeth, otherwise they will not be in synchromesh. On subsequent revolutions the “hills” of one gear would eventually bump into the “hills” of the mating gear.

In order to form the shape modified gears properly, the ratio determined at each of the plurality of angular positions of the rotating member is formed with respect to a reference value of 1.00 (a radius of a circular gear) to obtain a “difference value” associated with each of the plurality of angular positions.

Then the difference value associated with each of the plurality of angular positions is divided by two to obtain half the difference value for each of the plurality of angular positions.

For example, if at a particular angular position in the cycle one gear has a radius of 1.08 and the other gear has a radius of 1.00, then the “difference value” is 0.08. That “difference value” is divided in half to obtain half the difference value of 0.04.

The shape of one of the shape modified gears (that is, the length of its radii) is obtained by modifying the length of each of its radii by a function of the ratio, specifically, half of the difference value, for each of the plurality of angular positions. The shape of the other shape modified gear (that is, the length of its radii) is obtained by modifying the length of each of its radii by a function of the ratio, specifically, half of the difference value, for each of the plurality of angular positions. However, in each set of aligned radii, the length of the radius of one shape modified gear is modified in the opposite direction with respect to the length of the radius of the other shape modified gear. Thus, if the modification of the length of a particular radius of one of the shape modified gears creates a “hill”, the modification of the length of the aligned radius of the other shape modified gear must create a “valley” and visa versa.

Thus, subtracting 0.04 (one half the difference value of 0.8) from the “hill” of a gear with the radius of 1.08 would result in a “hill” of 1.04 length at that radius and subtracting the same 0.04 from the aligned radius of 1.00 of the other gear results in a gear with a “valley” of 0.96 (the difference being the same 0.08). If that is done at each angular position, for each pair of aligned radii, the result will be a uniform distance between the axes of rotation of the gears at all angular positions Thus, the distance between the axes of rotation of the gears each will remain the same relative to each other throughout the rotation cycle and the gear shafts, located at the center points of the respective gears, will not vacillate.

Similarly, further along in the rotation cycle, if the “difference value” is 0.06 and the length of the radius of one of the shape modified gears is a “valley” of 0.94, half the “difference value” (0.03) is removed from that radius to form a radius with a length of 0.97. That same value (half the “difference value” of 0.03 is added to the aligned radius of length 1.00 to form a “hill” at a radius of 1.03.

In this manner, the “wave train signature” illustrated in FIG. 1 for the rotating member connected to the two cylinder engine can be seen as being “wrapped” onto a gearset illustrated in FIG. 2, where the shape modified gears 10 and 12 appear to be nearly circular but are actually slightly modified in shape in accordance with the present invention. Because these are relatively minor variations, the gear will appear to be generally round, but slightly off. Gearset for smoother running engines will be even more “round.”

When the gearset is connected to an engine, it is usually preferable that the drive gear 10 be fixed on the output end of the crankshaft, at the point where it leaves the engine, before the flywheel. The driven gear 12 would then be fixed to a shaft connected to the components of the vehicle or machinery being driven by the engine. However, for some applications it may be best to locate the gearset in another location, for example, just before a driven wheel or propeller.

Referring now to FIGS. 3 and 4, the four cylinder, four stroke engine whose angular velocity “wave train signature” is illustrated in FIG. 3 has twice the number of cylinders as the engine whose signature is illustrated in FIG. 1. That means twice the number of “firings,” “explosions,” “pushes,” or “bangs” per cycle. More firings per rotation of the crankshaft results a smoother running engine. Almost always the maximum amplitude of the signature of such an engine is not as dramatic as an engine with fewer cylinders, but is still evident.

FIG. 3 illustrates that with a four cylinder engine there are twice as many hills and valleys per revolution as compared to the two cylinder engine. Since the signature for each of the half cycles is nearly identical, one may consider each of the half cycles to be a complete signature for purposes of applying the present invention. The above method is then applied as described above, but instead of applying the result to the entire gear of each gear in the gearset, it is applied to each half lobe of each gear in the gearset.

Thus, each gear of the gearset resulting from the application of the above method would have two signatures per revolution, one for each half. As illustrated FIG. 4, the shape of half gear “da” is identical to the shape of half gear “db”. Similarly, the shape of half gear “Da” is the same as the shape of half gear “Db.” It should be noted that the hills and valleys of the gears in FIG. 4 have been somewhat exaggerated for purposes of illustration.

The method of the present invention can be applied in the identical manner to form signature gearsets for a six or eight cylinder engines.

The more cylinders an engine has, the smoother it will run. Additionally, the faster the crankshaft rotates, the smoother the engine will run. Nevertheless internal combustion engines they are still “impulse engines” and the angular velocity of the crankshaft can be further “smoothed” by the present invention.

If a four cylinder engine has two signatures per cycle, then a six cylinder engine will have three signatures per cycle, an eight cylinder engine will have four signatures per cycle and so on. The present invention can be applied to any engine simply by repeating the method of forming the gears in the gearset as many times as is required.

On the other hand, the invention can be applied to single cylinder, four stroke engines. Because such engines have only a single combustion for every two revolutions, the output speed should be “geared down” to half speed before the gearset. After the gearset, the speed could be “geared up” to the original speed.

For two stroke engines, the gearset will be twice as fast because the engine is operating at twice the combustion rate.

If applied to smooth the vibrations of an internal combustion engine, then the apparatus can be employed to reduce the number of cylinders. With equal displacements, a six cylinder may run as smooth as an eight; a four as smooth as a six, a three as smooth as a four, and so on. Fewer cylinders means fewer parts, hence a simpler mechanism. For example, should a four replace a six, there would be two less pistons, two less connecting rods, four less valves, four less valve springs, fewer piston rings and so on. Additionally the crankshaft will be shorter (less twist) and less complicated to make. The camshafts will be shorter and less complicated to make. The ignition system will be simpler, so will the intake and exhaust manifolds.

Since the torque of an engine can be plotted in a manner similar to angular velocity, gearset for altering torque can be formed using the method of the present invention.

It will now be appreciated that the present invention relates to a method and apparatus for altering (minimizing or maximizing) a characteristic (the angular velocity or torque) variations of an engine consisting of a set of engaged noncircular gears shaped as a function of the wave train signature of the engine to which the gearset is connected. In other words, whatever the source of energy of a rotating member, the wave train signature of the rotating member can be “wrapped” around circular gears to form a noncircular gearset that alters the variations thereof.

While only a limited number of preferred embodiments of the present invention have been disclosed for purposes of illustration, it is obvious that many modifications and variations could be made thereto. It is intended to cover all of those modifications and variations which fall within the scope of the present invention, as defined by the following claims.

I claim:

1. A method for minimizing angular velocity variations of a rotating member utilizing a gearset connected to the member, wherein the gearset includes engaged gears, the method comprising the step of modifying the shape of each of first and second circular gears, each having an axis of rotation located at the center point thereof, to form engaged gears each having a noncircular shape that is a function of the “wave train signature” of the rotating member to which the gearset is connected.

2. The method of claim 1 wherein the step of modifying the shape of each of the gears includes the step of determining a ratio for a plurality of angular positions of the rotating member in a rotation cycle thereof by dividing the actual instantaneous angular velocity of the rotating member at each of the plurality of angular positions by the desired instantaneous angular velocity of the rotating member at each of the plurality angular positions.

3. The method of claim 2 wherein the step of modifying the shape of each of the gears further includes the step of determining the ratio for each of the plurality of angular positions of the rotating shaft as compared to 1.00 to obtain a “difference value” associated with each of the plurality of angular positions.

4. The method of claim 3 wherein the step of modifying the shape of each of the gears further includes the step of dividing the “difference value” associated with each of the plurality of angular positions by two to obtain half the difference value for each of the plurality of angular positions.

5. The method of claim 4 wherein the step of modifying the shape of each of the gears further includes the step of forming one of the noncircular gears by modifying the length of the radius of a circular gear as a function of half the difference value, at each of the plurality of angular positions.

6. The method of claim 5 wherein the step of modifying the shape of each of the gears further includes forming the other of the noncircular gears by modifying the length of the radius of a circular gear as a function of half the difference value, at each of the plurality of angular positions.

7. The method of claim 1 wherein the step of modifying the shape of each of the gears further includes the step of repeating the step of modifying the gears for additional cylinders in the engine driving the rotating member.

8. Apparatus for minimizing angular velocity variations of a rotating member including a gearset connected to the member, said gearset comprising shape modified first and second circular engaged gears, each of said first and second circular gears having an axis of rotation located at its center point and a modified shape that is a function of the “wave train signature” of the rotating member to which the gearset is connected.

9. The apparatus of claim 8 wherein each of said gears comprises a plurality of spaced radii each having a length that is a function of a ratio of the rotating member at a plurality of angular positions in a rotation cycle thereof corresponding to the position of the radius obtained by dividing the actual instantaneous angular velocity of the rotating member at each of the angular positions by the desired instantaneous angular velocity of the rotating member at each of the plurality angular positions.

10. The apparatus of claim 9 wherein the length of the radius at each of the plurality of angular positions is a function of the “difference value” obtained by subtracting the determined ratio from 1.00.

11. The apparatus of claim 10 wherein said the length of the radius at each of the plurality of angular positions is further obtained by dividing the “difference value” associated with each of the plurality of angular positions by two to obtain half the difference value.

12. The apparatus of claim 11 wherein the length of the radius of one of said shape modified gears at each of the plurality of angular positions is further obtained by modifying the length of the radius of a circular gear as a function of half the difference value, at each of the plurality of angular positions.

13. The apparatus of claim 12 wherein the length of the radius of the other shape modified gear at each of the plurality of angular positions is further obtained by modifying the length of the radius of a circular gear as a function of half the difference value, at each of the plurality of angular positions.

14. The apparatus of claim 13 wherein, in each set of aligned radii of the shape modified gears, the length of the aligned radii are modified in opposite directions.

15. The apparatus of claim 8 wherein the shape of each of the shape modified gears is determined by repeating the modification of the gears for additional cylinders in the engine driving the rotating member.
